(19) United States
(12) Patent Application Publication
(10) Pub. No.: US 2025/0078096 A1
(43) Pub. Date: Mar. 6, 2025

(54) ACCOUNTING METHOD FOR CARBON FOOTPRINT OF LEATHER PRODUCT

(71) Applicant: SICHUAN UNIVERSITY, Chengdu City (CN)

(72) Inventors: Chunhua WANG, Chengdu City (CN); Wei LIN, Chengdu City (CN); Le YANG, Chengdu City (CN); Jianfei ZHOU, Chengdu City (CN); Bi SHI, Chengdu City (CN)

(73) Assignee: SICHUAN UNIVERSITY, Chengdu City (CN)

(21) Appl. No.: 18/822,218

(22) Filed: Sep. 1, 2024

(30) Foreign Application Priority Data
Aug. 31, 2023 (CN) 202311114997.9

(51) Int. Cl. G06Q 30/018

(52) U.S. Cl. CPC G06Q 30/018

(57) ABSTRACT

Some embodiments of the disclosure provide accounting methods for carbon footprints of leather products. In some examples, the accounting method includes the following steps: firstly, determining a system boundary for a carbon footprint in a life cycle of a leather product; dividing the carbon footprint into a raw material production and transportation stage, a leather product production stage, and a leather product transportation and distribution stage within the system boundary for the leather product; determining carbon emission source inventories of the stages and emission factors thereof in combination with process and flow characteristics of the stages, and then constructing carbon emission accounting models of the stages, and calculating carbon footprint data of the stages, and, finally, obtaining the carbon footprint of the leather product.

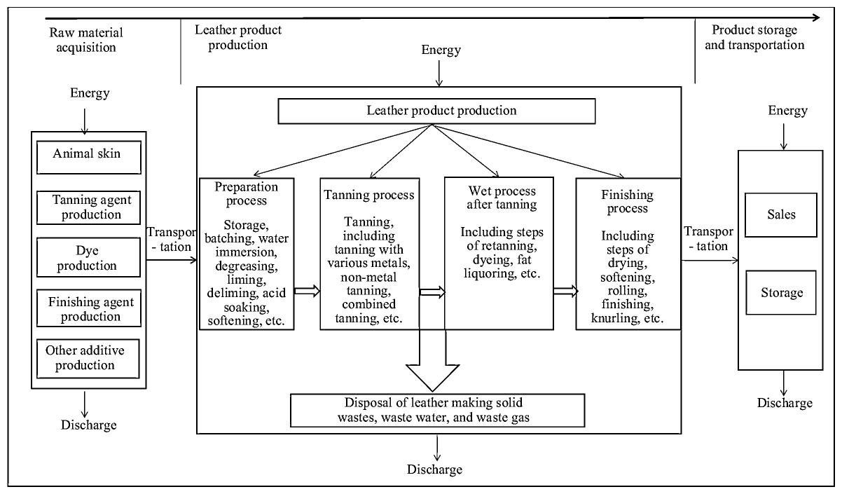

### CROSS REFERENCE TO RELATED APPLICATIONS

This application claims priority to Chinese patent application number 202311114997.9, filed on Aug. 31, 2023, the disclosure of which is incorporated by reference herein in its entirety.

### FIELD OF THE DISCLOSURES

The disclosure relates generally to the field of leather making. More specifically, the disclosure relates to accounting methods for a carbon footprints of leather products.

### BACKGROUND

With the approaching of the goals of carbon emissions peak and carbon neutrality and China attaching more importance to sustainable development, carbon accounting has become an important part in both domestic trade and international trade. The carbon footprint is an index for measuring carbon emissions of a certain group or product, which, for a product, generally refers to a total quantity of greenhouse gas generated by a certain product in a life cycle thereof.

In fact, internationally, part of industries has started to require sellers to provide carbon footprint accounting reports. For example, in battery trade, it is required that trading enterprises must show carbon footprints of their battery products after 2024. In international trade, it is highly possible to create a green trade barrier by means of defining greenhouse gas emissions of products. Therefore, in order to both respond to the goals of carbon emissions peak and carbon neutrality and sustainable development and improve the competitiveness of products and better respond to future opportunities and meet future challenges, the accounting of carbon footprints should be of primary importance.

The leather making industry has been a long-standing industry in China. From ancient times, ancestors soaked animal skins in tree sap for making clothes. Since modern times, the leather making industry in China has also been developing vigorously. Animal skins that are considered as wastes are specially processed into products with special functions. When the goals of carbon emissions peak and carbon neutrality approach, the leather making industry must keep pace with the times to actively carry out carbon emission accounting of leather products and promote green transformation of the industry. By means of accounting of carbon emissions of products, a leather making enterprise may find leather making raw materials that have lower carbon emissions and are more environmentally friendly and improve the environmental friendliness of its own products from the perspective of raw materials on the one hand; and on the other hand, what steps have carbon emissions greatly influencing the overall carbon emissions of products and what steps have a great room for improvement may be determined by carbon emission accounting of a production process. Thus, green transformation of the enterprise may be promoted by improving the product process thereof.

The life cycle assessment method has been widely applied to carbon accounting of enterprises of the manufacturing industry. GB/T 24040 defines a life cycle as a series of stages successively joined in a product system, including acquiring raw materials from nature or natural resources till final disposal. Life cycle assessment refers to calculating a sum of carbon emissions produced in a “cradle to grave” or “cradle to gate” process of a product (including, but be not limited to, raw material acquisition, manufacturing, transportation, selling, use, and abandonment stages) to obtain a total quantity of greenhouse gas emissions of the product in a life cycle thereof, namely the product carbon footprint, which is a sum of greenhouse gas emissions and removals expressed in carbon dioxide equivalent. The leather making enterprise may perform life cycle assessment on carbon footprints of leather products so that the products may be approved as environment-friendly. The capability of the enterprise to tackle the green trade barrier may be improved. The enterprise may also be allowed to know the contributions of processes of its own products in entire life cycles thereof to total carbon emissions. The problems that the enterprise needs to face in green low carbon transformation may be clarified. Moreover, on the basis of quantifying carbon emissions, the leather making enterprise may promote coordinated energy conservation and emission reduction in the whole industrial chain by improving the processes and selecting more environmentally friendly raw materials.

At present, foreign countries play a dominant role in carbon footprint assessment criteria. The existing international ISO14067 and PAS2050 are two carbon footprint accounting and approval standards that have been extensively used at present. Foreign carbon footprint identification products are developing with the development and continuous perfection of product carbon footprint analysis. Many enterprises have started to manage and optimize the production and transportation process according to the carbon footprint analysis results. The product carbon footprint assessment result is an important characterization parameter for measuring a degree of development of green economy and is becoming a necessary certificate for import and export products in international trade.

As carbon footprint assessment related documents have been continuously issued recently in foreign countries, enterprises in China start to actively concern and carry out product carbon emission accounting. A plurality of carbon footprint assessment criteria for products have been established in several cities such as Beijing, Shanghai, and Chengdu. The life cycle assessment method has been used for carbon footprint accounting of products in the industries such as cement building and steels. However, there is currently no scientific and professional product carbon footprint assessment in light industries such as leather making at home and abroad. This is because there is a great difference between the leather making industry and the above industries. Leather making production is very complicated and needs to undergo dozens of steps. From the perspective of fabrication process, there is no fixed template for the leather making process. Instead, the leather making process is carried out depending on the animal skins used. Due to the influences of factors such as a source and type of a raw animal skin, weather, region, and temperature, the leather making processes of different enterprises greatly differ. Moreover, there is no related study or unified stipulation with respect to a system boundary required by the carbon footprint of a leather product. Therefore, carbon emission accounting in other industries is not suitable for carbon footprint assessment on a leather product.

In view of the problem of currently lacking a method for carbon footprint accounting of leather products, the present disclosure selects the life cycle assessment method to perform carbon accounting on a supply chain of leather products and establishes an accounting model for the carbon footprint of a leather product in combination with a leather product production process. In the present disclosure, a system boundary for a leather product is first determined and established. In general, from the perspective of the system boundary, the system boundary should in principle include each stage of a life cycle of a product, including raw material acquisition, manufacturing, distribution, use, and recycling/disposal. A flowchart of stages that carbon footprint assessment of a product covers should be plotted, which must encompass several unit processes of raw material acquisition, product production, and product distribution (including transportation). However, since leather products will generally be used in industries such as furniture, shoemaking, clothing, automobiles, and bags and suitcases to be made into a plurality of products without being used directly as final products, the leather industry may be regarded as the upstream manufacturer for these industries. Therefore, the product use and recycling/disposal unit processes may not be included within the system boundary. Accordingly, an accounting method for the carbon footprint provided in the present disclosure is aimed specially at the leather industry. It is determined that the “cradle to gate” life cycle assessment method is used for accounting.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

An accounting method for a carbon footprint of a leather product includes following steps.

Step 1, determining a system boundary for a carbon footprint in a life cycle of a leather product.

Step 2, dividing the carbon footprint into a raw material production and transportation stage, a leather product production stage, and a product transportation and distribution stage within the system boundary.

Step 3, collecting data of raw material production and transportation, leather product production, and product distribution and transportation according to a production of the leather product.

Step 4, determining carbon emission source inventories and emission factors in the three stages, respectively.

Step 5, constructing carbon emission accounting models for the raw material production and transportation stage, the leather product production stage, and the leather product transportation and distribution stage with carbon emission factors of carbon emission sources, respectively.

Step 6, obtaining the carbon footprint of the leather product using the carbon emission accounting models for the three stages.

Accounting of the carbon footprint of the leather product is as follows.

$${E}_{leather product carbon footprint} = {E}_{raw material acquisition} + {E}_{product production} + {E}_{product transportation} \qquad ( 1 )$$

Here, E_{leather product carbon footprint} represents a carbon footprint in a leather product production process, E_{raw material acquisition} represents a carbon footprint in a leather raw material acquisition process, including carbon emissions from energy consumption by raw hides acquisition and leather material production as well as transportation of raw materials, E_{product production} refers to a carbon footprint in the leather product production process, mainly including carbon emissions caused by energy consumption in a production activity and energy consumption in an in-plant transportation process and carbon emissions caused by waste disposal, and E_{product transportation} represents a carbon footprint in a product transportation process, namely carbon emissions generated in a process of transporting a product that a leather making plant has intended to sell from the leather making plant to factories, sellers, and sales places.

Accounting of the carbon footprint of raw material acquisition is as follows.

$${E}_{raw material acquisition} = \sum ( {C}_{i} \times R {F}_{i} ) + \sum ( {D}_{i} \times {E}_{i} \times {F}_{i} ) \qquad ( 2 )$$

Here, i represents different raw material types of an acquired raw hide and a prepared leather material, Cᵢ represents a consumption of an ith raw material, in unit of kg, RFᵢ represents an emission factor of greenhouse gas of the ith raw material, in unit of kg CO₂e/kg, Dᵢ represents a transport mileage of the ith raw material, in unit of km, Eᵢ represents a mass of the ith raw material transported, in unit of t, and Fᵢ represents an emission factor of greenhouse gas corresponding to a mode of transportation of the ith raw material, in unit of kg CO₂e/tkm.

The leather product production process includes a preparation process, a tanning process, wet processing after tanning, and a finishing process. Carbon emissions in a production activity and a transportation process thereof are from energy consumption and a waste disposal process. Accounting of the carbon footprint of the leather product production process is as follows.

$${E}_{production process} = {E}_{energy} + {E}_{waste disposal} \qquad ( 3 )$$

Here, E_{energy} represents a carbon footprint of energy consumption in the production activity, in unit of kg CO₂e, and E_{waste disposal} represents a carbon footprint of the waste disposal process, in unit of kg CO₂e.

The energy consumption of the leather product production and in-plant transportation is mainly composed of a fuel, electric power, and heat:

$${E}_{energy} = {E}_{fuel} + {E}_{electric power} + {E}_{h e a t} \qquad ( 4 )$$

Here, E_{fuel} represents a carbon footprint of fuel combustion, in unit of kg CO₂e, E_{electric power} represents a carbon footprint of using purchased electric power, in unit of kg CO₂e, and Eₕₑₐₜ represents a carbon footprint of using purchased heat (steam and hot water), in unit of kg CO₂e.

Accounting of the carbon footprint of fuel combustion is as follows.

$${E}_{fuel} = \sum ( {C}_{k} \times {H}_{k} ) \qquad ( 5 )$$

Here, k represents a different fuel type, Cₖ represents a consumption of a kth fuel, in unit of kg, and Hₖ represents an emission factor of greenhouse gas of the kth fuel, in unit of kg CO₂e/kg, Accounting of the carbon footprint of using the purchased electric power is as follows. If an enterprise uses accurately measurable electric power from a renewable energy source, the quantity of electricity is not included in electric power consumption:

$${E}_{electric power} = E A \times E F \qquad ( 6 )$$

Here, EA represents activity level data of the purchased electric power, in unit of GJ (kwh), and EF represents an emission factor of greenhouse gas of the purchased electric power, in unit of kg CO₂e/kwh.

Accounting of the carbon footprint of using the purchased heat is as follows.

$${E}_{h e a t} = H A \times FA \qquad ( 7 )$$

Here, HA represents activity level data of the purchased heat, in unit of GJ, and

FA represents an emission factor of greenhouse gas of the purchased heat, in unit of kg CO₂e/GJ.

Accounting of the carbon footprint of leather product waste disposal is as follows.

$${E}_{waste disposal} = W A \times W F \qquad ( 8 )$$

Here, WA represents activity level data of waste disposal, in unit of kg, and WF represents an emission factor of greenhouse gas of waste disposal, in unit of kg CO₂e/kg.

The product transportation process is a process from a manufacturer to a warehouse, a seller, and a distribution place, and carbon footprints for different types of vehicles, transport mileages, and masses of transported goods in the transportation process are taken into consideration in the product transportation. Specific accounting is as follows.

$$E product transportation = D A \times E A \times F A \qquad ( 9 )$$

Here, DA represents a transport mileage of the product, in unit of km, EA represents a mass of the product transported, in unit of t, and FA represents an emission factor of greenhouse gas corresponding to a mode of product transportation, in unit of kg CO₂e/tkm.

### BRIEF DESCRIPTION OF THE DRAWINGS

Illustrative embodiments of the present disclosure are described in detail below with reference to the attached drawing figures.

The FIGURE is a diagram illustrating a system boundary for a life cycle of a leather product according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

In some embodiments, an accounting method for a carbon footprint of a leather product may include the following steps.

In step 1, a system boundary for a carbon footprint is determined in a life cycle of a leather product.

In step 2, the carbon footprint is divided into a raw material production and transportation stage, a cowhide shoe upper leather product production stage, and a product transportation and distribution stage within the system boundary.

In step 3, carbon emission source inventories of the stages are determined according to a production process of the cowhide shoe upper leather product.

The carbon footprint of the cowhide shoe upper leather product is entirely composed of 3 parts. Raw material acquisition described below may include carbon emissions caused by the production of leather making raw materials such as cowhide, a chrome tanning agent, an anionic dye, a fatliquor, and a finishing agent, and carbon emissions produced by production from a plant to a leather making factory. The product production may include carbon emissions resulting from energy loss in the leather making process, energy loss during in-plant material handling, and disposal of leather making solid wastes, waste water, and waste gas. The carbon footprint during the product transportation refers to carbon emissions generated in a process of transporting a product that a leather making plant has intended to sell from the leather making plant to factories, sellers, and sales places.

$${E}_{leather product carbon footprint} = {E}_{raw material acquisition} + {E}_{product production} + {E}_{product transportation} \qquad ( 1 )$$

The cowhide shoe upper leather production process may include a preparation process, a tanning process, wet processing after tanning, and a finishing process. Carbon emissions in a production activity and a transportation process thereof are from energy consumption and a waste disposal process. Accounting of the carbon footprint of the cowhide shoe upper leather production process is as follows.

$${E}_{production process} = {E}_{energy} + {E}_{waste disposal} \qquad ( 2 )$$

Here:
E_{energy} represents a carbon footprint of energy consumption in the production activity, in unit of kg CO₂e; and
E_{waste disposal} represents a carbon footprint of the waste disposal process, in unit of kg CO₂e.

The energy consumption of the cowhide shoe upper leather production is mainly composed of a fuel, electric power, and heat:

$${E}_{energy} = {E}_{fuel} + {E}_{electric} + {E}_{heat} \qquad ( 3 )$$

Here:
E_{fuel} represents a carbon footprint of fuel combustion, in unit of kg CO₂e;
E_{electric power} represents a carbon footprint of using purchased electric power, in unit of kg CO₂e; and
Eₕₑₐₜ represents a carbon footprint of using purchased heat (steam and hot water), in unit of kg CO₂e;
Accounting of the carbon footprint of fuel combustion is as follows.

$${E}_{fuel} = \sum ( {C}_{k} \times {H}_{k} ) \qquad ( 4 )$$

Here:
k represents a different fuel type;
Cₖ represents a consumption of a kth fuel, in unit of kg; and
Hₖ represents an emission factor of greenhouse gas of the kth fuel, in unit of kg CO₂e/kg.

Accounting of the carbon footprint of using the purchased electric power is as follows. If an enterprise uses accurately measurable electric power from a renewable energy source, the quantity of electricity is not included in electric power consumption:

$${E}_{electric power} = EA \times EF \qquad ( 5 )$$

Here:
EA represents activity level data of the purchased electric power, in unit of GJ (kwh); and
EF represents an emission factor of greenhouse gas of the purchased electric power, in unit of kg CO₂e/kwh.

Accounting of the carbon footprint of using the purchased heat is as follows.

$${E}_{heat} = HA \times FA \qquad ( 6 )$$

Here:
HA represents activity level data of the purchased heat, in unit of GJ; and
FA represents an emission factor of greenhouse gas of the purchased heat, in unit of kg CO₂e/GJ.

Accounting of the carbon footprint of cowhide shoe upper leather waste disposal is as follows.

$${E}_{waste disposal} = WA \times WF \qquad ( 7 )$$

Here:
WA represents activity level data of waste disposal, in unit of kg; and
WF represents an emission factor of greenhouse gas of waste disposal, in unit of kg CO₂e/kg.

The product transportation process is a process from a manufacturer to a warehouse, a seller, and a distribution place, and carbon footprints for different types of vehicles, transport mileages, and masses of transported goods in the transportation process are taken into consideration in the product transportation. Specific accounting is as follows.

$$Eproduct transportation = DA \times EA \times FA \qquad ( 8 )$$

Here:
DA represents a transport mileage of the product, in unit of km;
EA represents a mass of the product transported, in unit of t; and
FA represents an emission factor of greenhouse gas corresponding to a mode of product transportation, in unit of kg CO₂e/tkm.

In step 4, emission factors of carbon emission sources in the stages are determined, respectively.

In step 5, carbon emission accounting models for the raw material production and transportation stage, the cowhide shoe upper leather production stage, and the leather product transportation and distribution stage are constructed with the carbon emission factors of the carbon emission sources, respectively.

In step 6, the carbon footprint of the cowhide shoe upper leather product is obtained using the carbon emission accounting models for the three stages.

Various embodiments of the disclosure may have one or more of the following effects. In some embodiments, the disclosure may select the life cycle assessment method to perform carbon accounting on a supply chain of leather products and may establish an accounting model for a carbon footprint of a leather product in combination with a leather product production process. In other embodiments, according to the disclosure, deep analysis may be performed on carbon emission source inventories and carbon emissions thereof in the leather product production process, and a carbon footprint accounting model for a leather product may be established. Carbon footprint accounting of the leather product may be achieved. It may be of practical significance and practical value for product carbon footprint accounting by a leather making enterprise. In further embodiments, with the leather product as the object of research in the present disclosure and the life cycle assessment method as a research method, types of carbon emission sources in the life cycle of the leather product from raw material production to product sales may be analyzed, and carbon emissions in the whole process from the production to the final distribution of the leather product may be known.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. An accounting method for a carbon footprint of a leather product, specifically comprising:
(1) determining a system boundary for a carbon footprint in a life cycle of a leather product;
(2) dividing the carbon footprint into a raw material production and transportation stage, a leather product production stage, and a leather product transportation and distribution stage within the system boundary;
(3) collecting data of raw material production and transportation, leather product production, and product distribution and transportation processes according to a production process of the leather product;
(4) determining carbon emission source inventories and emission factors in the three stages, respectively;
(5) constructing carbon emission accounting models for the raw material production and transportation stage, the leather product production stage, and the leather product transportation and distribution stage with carbon emission factors of corresponding carbon emission sources, respectively; and
(6) obtaining carbon footprints of the stages using the carbon emission accounting models for the three stages, wherein accounting of the carbon footprint of the leather product is shown below:
$${E}_{leather product carbon footprint} = {E}_{raw material acquisition} + {E}_{product production} + {E}_{product transportation} , \qquad ( 1 ) ,$$
wherein:
E_{leather product carbon footprint} represents the carbon footprint of the leather product,
E_{raw material acquisition} represents a carbon footprint in a leather raw material acquisition process, comprising carbon emissions during raw hides acquisition and leather material production as well as transportation of raw materials,
E_{product production} refers to a carbon footprint in the leather product production process, mainly comprising carbon emissions caused by energy consumption in a production activity and energy consumption in an in-plant transportation process and carbon emissions caused by waste disposal, and
E_{product transportation} represents a carbon footprint in a product transportation process, namely carbon emissions generated in a process of transporting a product that a leather making plant has intended to sell from the leather making plant to factories, sellers, and sales places.

2. The accounting method according to claim 1, wherein the carbon emission accounting model for the raw material production and transportation stage is as follows:
$${E}_{raw material acquisition} = \sum ( {C}_{i} \times {RF}_{i} ) + \sum ( {D}_{i} \times {E}_{i} \times {F}_{i} ) , \qquad ( 2 )$$
wherein:
i represents different raw material types of an acquired raw hide and a prepared leather material;
Cᵢ represents a consumption of an ith raw material, in unit of kg;
RFᵢ represents an emission factor of greenhouse gas of the ith raw material, in unit of kg CO2e/kg;
Dᵢ represents a transport mileage of the ith raw material, in unit of km;
Eᵢ represents a mass of the ith raw material transported, in unit of t; and
Fᵢ represents an emission factor of greenhouse gas corresponding to a mode of transportation of the ith raw material, in unit of kg CO2e/tkm.

3. The accounting method according to claim 1, wherein:
the leather product production process comprises a preparation process, a tanning process, wet processing after tanning, and a finishing process;
carbon emissions of the leather product production process are from energy consumption and a waste disposal process;
the carbon emission accounting model for the leather production process is as follows:
$${E}_{production process} = {E}_{energy} + {E}_{waste disposal} , \qquad ( 3 )$$
wherein:
E_{energy} represents a carbon footprint of energy consumption in the production activity, in unit of kg CO₂e, and
E_{waste disposal} represents a carbon footprint of the waste disposal process, in unit of kg CO₂e;
$${E}_{energy} = {E}_{fuel} + {E}_{electric power} + {E}_{heat} , \qquad ( 4 )$$
wherein:
E_{fuel} represents a carbon footprint of fuel combustion, in unit of kg CO₂e,
E_{electric power} represents a carbon footprint of using purchased electric power, in unit of kg CO₂e, and
Eₕₑₐₜ represents a carbon footprint of using purchased heat (steam and hot water), in unit of kg CO₂e;
accounting of the carbon footprint of fuel combustion is as follows:
$${E}_{fuel} = \sum ( {C}_{k} \times {H}_{k} ) , \qquad ( 5 )$$
wherein:
k represents a different fuel type,
Cₖ represents a consumption of a kth fuel, in unit of kg, and
Hₖ represents an emission factor of greenhouse gas of the kth fuel, in unit of kg CO₂e/kg;
accounting of the carbon footprint of using the purchased electric power is as follows; if an enterprise uses accurately measurable electric power from a renewable energy source, quantity of electricity is not comprised in electric power consumption:
$${E}_{electrc power} = EA \times EF , \qquad ( 6 )$$
wherein:
EA represents activity level data of the purchased electric power, in unit of GJ (kwh), and
EF represents an emission factor of greenhouse gas of the purchased electric power, in unit of kg CO₂e/kwh;
accounting of the carbon footprint of using the purchased heat is as follows:
$${E}_{heat} = HA \times FA , \qquad ( 7 )$$
wherein:
HA represents activity level data of the purchased heat, in unit of GJ, and
FA represents an emission factor of greenhouse gas of the purchased heat, in unit of kg CO₂e/GJ; and
accounting of the carbon footprint of leather product waste disposal is as follows:
$${E}_{waste disposal} = WA \times WF , \qquad ( 8 )$$
wherein:
WA represents activity level data of waste disposal, in unit of kg, and
WF represents an emission factor of greenhouse gas of waste disposal, in unit of kg CO₂e/kg.

4. The accounting method according to claim 1, wherein:
the leather product transportation and distribution process is a process of transporting the leather product from a manufacturer to a warehouse, a seller, and a distribution place;
carbon footprints for different modes of product transportation (types of vehicles), transport mileages, and masses of transported goods in the transportation process are taken into consideration; and
the carbon emission accounting model for the leather product transportation and distribution stage is as follows:
$${E}_{product transportation} = DA \times EA \times FA , \qquad ( 9 )$$
wherein:
DA represents a transport mileage of the product, in unit of km,
EA represents a mass of the product transported, in unit of t, and
FA represents an emission factor of greenhouse gas corresponding to a mode of product transportation, in unit of kg CO₂e/tkm.
